(19) United States
(12) Patent Application Publication
(10) Pub. No.: US 2015/0290597 A1
(43) Pub. Date: Oct. 15, 2015

(54) AERATION DEVICE FOR BIOREACTORS

(71) Applicant: Sarfaraz K. Niazi, Deerfield, IL (US)

(72) Inventor: Sarfaraz K. Niazi, Deerfield, IL (US)

(73) Assignee: Therapeutic Proteins International, LLC, Chicago, IL (US)

(21) Appl. No.: 14/249,137

(22) Filed: Apr. 9, 2014

(51) Int. Cl. B01F 3/04

(52) U.S. Cl. CPC B01F 3/0451

(57) ABSTRACT

An aeration and mixing device for disposable flexible bioreactors comprising a mesh of interconnected perforated disposable tubes to form a structure to cover essentially the entire bottom surface of a disposable flexible bioreactor and wherein a continuous flow of gases through the perforations in the tubes provides an aeration and a mixing function.

### FIELD OF THE INVENTION

The invention relates to an aeration device for bioreactors comprising a mesh of perforated tubes disposed in a bioreactor wherein the flow of gases through the perforated tubes provides a mixing and aeration of the contents of bioreactor.

### BACKGROUND OF THE INVENTION

Provision of an oxygen supply is a key factor in cellular metabolic processes. Although animal cell cultures consume substantially less oxygen than bacteria and yeast cultures, ensuring an efficient supply is the greatest challenge facing the operation of a cell culture bioreactor. In addition to supplying the cells with oxygen, the concentration of dissolved carbon dioxide also plays a part as a controlled variable.

There are two conventional aeration methods: aerating the headspace of the bioreactor and direct injection of the gases through aeration tubes or rings. For this purpose, use is made not only of the aeration rings known from fermenters with bores or gas outlet openings of for example 0.8 mm but also of “microspargers” made from sintered plastics with pore sizes of for example 20 to 45 μm, which likewise form gas outlet openings. Both kinds have specific advantages and drawbacks.

The aeration ring produces larger bubbles, which means that higher gas throughput rates are required to achieve the same “oxygen transfer rate”. With its relatively large bubbles, the ring sparger is suitable for stripping or sweeping out CO2 with air, for example. With its relatively small bubbles, the microsparger is particularly suitable for supplying oxygen. One drawback, however, is that under unfavorable conditions foaming may occur due to the relatively smaller bubbles.

Aeration devices are used as part of automated bioreactor aeration systems, for example single-use reactors, the supply of air, oxygen, carbon dioxide and nitrogen being mutually independently controllable. Sensors for oxygen partial pressure and pH facilitate the control of these important process parameters.

WO 2009/122310 A2, WO 2009/115926 A2 and WO 2009/116002 A1 disclose a single-use bioreactor with a mixer and with an aeration device arranged on the bottom of the reactor interior. It is known here to arrange two aeration elements on the bottom, which take the form of opposing, mating ring segments.

Drawbacks of this aeration device, which has in principle proved effective, are that, on the one hand, it must be fastened in relatively complex manner to the bottom of the reactor and that, on the other hand, it is difficult to arrange a plurality of such aeration elements optimally relative to the stirrer or mixer.

An aeration device for bioreactors is furthermore known from WO 2008/088371 A2, in which for example two aeration elements with different gas outlet openings may be fastened to the bottom of the reactor.

One drawback here is that the aeration elements are fastened in relatively complex manner to the bottom of the reactor. A further drawback is that the individual aeration element is here not optimally arranged relative to the mixer.

Aeration device for bioreactors, US 20130175716 A1 reports an aeration device for bioreactors with an aeration element with gas outlet openings arranged in a housing, the aeration element taking the form of a microsparger, the gas outlet openings of which are in each case spaced apart from one another and have a size of between 100 μm and 200 μm. At least one second aeration element with gas outlet openings of a second size is preferably provided, the aeration elements being formed by a common housing with separate aeration channels.

This aeration device fails to provide adequate turbulence in the bioreactor media to provide a mixing function.

Movable aerator for membrane bioreactor, CN 202953862 U, reports utility model of a movable aerator for a membrane bioreactor. The movable aerator comprises an aeration pipeline, wherein a plurality of aeration holes arranged linearly are formed at the bottom of the aeration pipeline; an aeration branch pipe is inserted into each aeration hole; a rubber hose is sleeved on each aeration branch pipe; and the top of the aeration pipeline is flexibly connected with a membrane-bioreactor (MBR) membrane assembly in the membrane bioreactor. The movable aerator has the beneficial effects that when the movable aerator is used, bubbles are distributed uniformly, the turbulent flow distribution is good, a ‘blind area’ is not formed when the membrane surface is scrubbed, concentration polarization and membrane pollution are reduced, the filter performance of the membrane is well exerted, and the gas consumption is low under the same effect.

This invention is different as being mobile vis-à-vis the present invention that is stationary and produces turbulence by providing uniform distribution of gases throughout the bioreactor.

The object of the present invention is accordingly to improve the known aeration devices for bioreactors in such a manner that, on the one hand, they are simpler to use, are stationary and can be fastened if needed to a horizontal surface of a bioreactor to provide a pattern of aeration element for optimal gas absorption as well as optimal mixing eliminating the need for a mixing apparatus in the bioreactor.

### SUMMARY OF THE INVENTION

The objective of bioreactor aeration and mixing is achieved with an aeration device for bioreactors comprising a mesh of perforated tubes connected to form a structure of such size as to occupy essentially the entire base of a disposable bioreactor wherein the size of perforations in the tubes have such dimension that they discharge gases at a rate and volume to provide sufficient aeration as well as agitation to mix the contents of the bioreactor.

According to a preferred embodiment of the invention, the meshed structure takes the form of rectangular mesh installed at the base of a flexible rectangular bioreactor wherein the gases coming out of the structure provide a mixing function across the base of the bioreactor.

According to a preferred embodiment of the invention, the perforations in the tubes have an opening greater than 0.1 mm in diameter.

According to another preferred embodiment of the invention, the mesh can be suspended in the bioreactor.

According to another preferred embodiment of the invention, the mesh is anchored to the base of the bioreactor.

According to another preferred embodiment of the invention, the mesh is anchored in the vertical middle of the bioreactor.

According to another preferred embodiment of the invention, the mesh is anchored in the top surface of the media in the bioreactor.

### BRIEF DESCRIPTION OF THE DRAWINGS

FIG. 1 is a mesh structure of perforated tubes having 3 sections.

FIG. 2 is a mesh structure of perforated tubes with single gas inlet and no anchors.

### DETAILED DESCRIPTION OF THE INVENTION

Operation of bioreactors requires adequate aeration and mixing; generally, these functions are provided by two devices, a sparger and a mixer. However, a large number of cultures are poorly affected by excessive agitation and aeration, more particularly the mammalian cells. To provide an optimal environment for the growth of a variety of cultures ranging from yeasts to bacteria to mammalian cells to baculoviruses, there is a need to devise a system that is easy to use and provides both mixing and aeration functions in a stationary system. A review of the prior art shows that there are no devises or methods available that fulfill these preferred embodiment features.

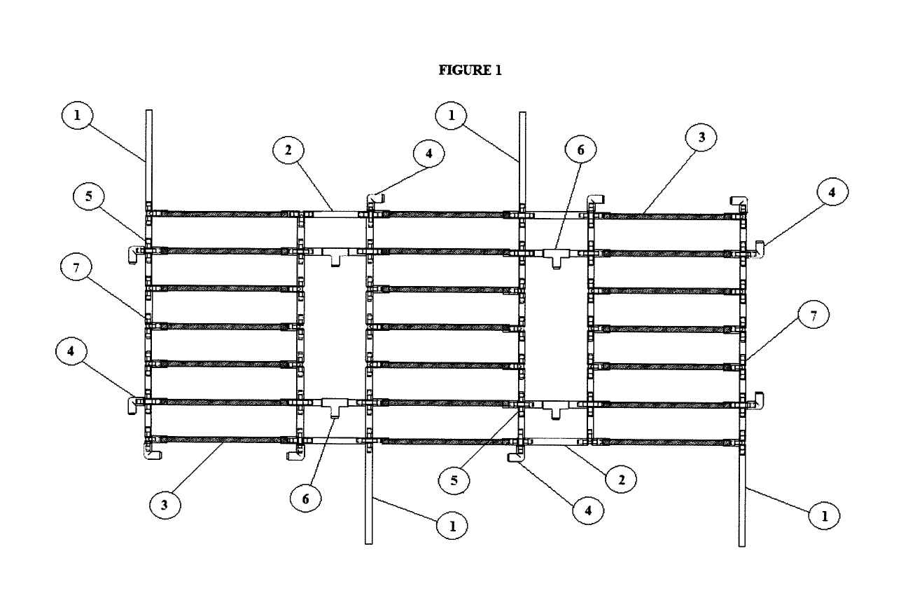

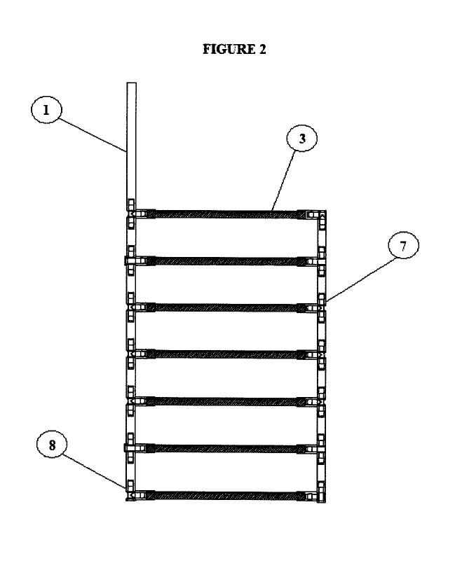

One or more sections of perforated tubing can be interconnected to form the mesh structure of the invention. FIG. 1 illustrates an example of a mesh structure having three sections. The gas inlet 1 is connected to the perforated tubes 3 through cross connectors 5 and T-connectors 7. The sections can be joined with connector tubes 2. The mesh structure can also be anchored to the bioreactor using elbow shaped anchors 4 and/or T-shaped anchors 6. FIG. 2 illustrates a single section without anchors.

In the present invention, the use is made of ordinary perforated tubes that can be made of a flexible material such as polyethylene, polyurethane, polypropylene, polytetrafluoroethylene, polyvinylidene fluoride, ethylvinyl acetate, polycarbonate, or nylon mesh or an inflexible material such as ceramic, metal, fiberglass, or plastic; the only requirement is that the tubes be perforated to allow flow of gases as a continuous stream. The opening or perforations in the tubes must be of such size as to create a uniform flow of bubbles without any “leaking” that comes if the pores are too large. The leaking also causes a drop in pressure in the tube preventing uniform aeration coming from the entire mesh. An appropriate size of pores will range from a few microns, such as 5 to 10 to hundreds of microns; the size of pores will depend on the size of the mesh, the pressure that can be sustained by the tubes as well as the mixing needs. For example, a larger pore configuration will require a much larger volume of aeration that may be detrimental to a biological culture in the media of bioreactors.

The mesh structure is used for aeration of cell culture. How the aeration is achieved is through perforated (porous) tubes arranged in a configuration that allows coverage of a horizontal surface or axis, e.g. the bottom layer of a 2-D single use bioreactor. Certain plastic materials available for use have a high buoyancy and therefore may need to be anchored or weighted. The mesh structure is able to stay submerged below the surface of the liquid in the bioreactor by anchor points which may be, e.g., inverted elbow connectors or T-shaped anchors, attached to ports. The anchor points restrain the mesh structure and maintain the anchor height throughout the process. One example of a material for the perforated tubing can be purchased from Porex Corporation (http://www.porex.com/technologies/materials/porous-plastics). Alternately, the mesh can be suspended in the liquid by a set of weights attached to the mesh to allow it to float despite the pressure from the exiting air that may push it upward.

In a more ideal situation, the mesh will be made part of a disposable bioreactor where it can be sterilized along with other parts of the bioreactor such as by using gamma radiation and would thus be readily available for use and discarded upon the completion of the bioreactor cycle.

### Example 1

### Testing of Mesh Structure in a Bioreactor

A 250 L bioreactor containing a mesh structure having 3 sections similar to FIG. 1 was submerged in 150 L of culture media. The agitation speed and airflow rate were adjusted according to the following table and the Mass transfer coefficient was calculated.

TABLE 1

| Agitation speed | Air flow rate | Mass transfer coefficient, |
|---|---|---|
| (rpm) | (LPM) | k_{La} (hr⁻¹) |
| 73 | 150 | 36.7 |
| 73 | 225 | 44.4 |
| 73 | 300 | 53.4 |
| 67 | 225 | 42.0 |
| 80 | 225 | 55.8 |

1. An aeration and mixing device for bioreactors comprising a plurality of perforated tubes interconnected to form a horizontal mesh disposed in a bioreactor, wherein the mesh is connected to one or more gas inlets.

2. The device of claim 1, wherein the mesh comprises essentially a horizontal surface or axis of the bioreactor.

3. The device of claim 1, further comprising one or more connectors for anchoring the mesh to the bioreactor.

4. The device of claim 1, wherein the perforated tubes have a porosity of 0.1 to 200 microns.

5. The device of claim 1, wherein the perforated tubes have a diameter ranging from 0.1 to 2 inches.

6. The device of claim 1, wherein the perforated tubes are comprised of a flexible material.

7. The device of claim 1, wherein the perforated tubes are comprised of an inflexible material.

8. The device of claim 6, wherein the flexible material comprises polyethylene, polyurethane, polypropylene, PVC, or nylon mesh.

9. The device of claim 7, wherein the inflexible material comprises ceramic, metal, fiberglass, or plastic.

10. The device of claim 1, wherein the horizontal mesh is disposable.

11. The device of claim 1, wherein the perforated tubes are connected using plastic connectors.

12. The device of claim 1, wherein mixing is achieved by flowing gas through the perforated tubes into the bioreactor.

13. A disposable bioreactor comprising an aeration and mixing device comprising a plurality of disposable perforated tubes interconnected to form a horizontal mesh, wherein the mesh is connected to one or more gas inlets.
